(19) United States
(12) Patent Application Publication
(10) Pub. No.: US 2024/0407959 A1
(43) Pub. Date: Dec. 12, 2024

(54) VEHICLE FOR DRIVING ON STAIRS OR A RAMP

(71) Applicant: SCEWO AG, Winterthur (CH)

(72) Inventor: Philip DREHER, Winterthur (CH)

(21) Appl. No.: 18/701,623

(22) PCT Filed: Oct. 5, 2022
(86) PCT No.: PCT/EP2022/077673

§ 371 Date: Apr. 16, 2024

(30) Foreign Application Priority Data
Oct. 19, 2021 (DE) 10 2021 127 085.5

(51) Int. Cl. A61G 5/06; A61G 5/10

(52) U.S. Cl. CPC A61G 5/061; A61G 5/066; A61G 5/1059; A61G 5/1078

(57) ABSTRACT

Vehicle for driving up stairs or a ramp, whereby the vehicle can be operated in one of the following operating modes:
a first operating mode, intended for a substantially flat surface, in which one or more wheels (3, 4) are driven,
a second operating mode, which is intended for driving up stairs or a ramp, in which a crawler track (5) is driven,
a third operating mode in which the height of a support for carrying and transporting a load is adjustable and the vehicle is supported on the crawler track (5) and a support wheel (10, 11),
whereby the vehicle has:
at least one first linear motor (7) for adjusting the crawler track (5),
a second linear motor (8) for adjusting the support wheel (10, 11),
a lifting mechanism on which the first linear motor (7) and the second linear motor (8) are arranged, and
a spring arranged on the lifting mechanism to relieve the first linear motor (7) and/or the second linear motor (8).

The invention relates to a vehicle for driving on stairs or a ramp, wherein the vehicle can optionally be operated in one of the following operating modes: a first operating mode, which is provided for a substantially level surface, in which one or more wheels are driven, a second operating mode, which is provided for driving on stairs or a ramp, in which a crawler track is driven, a third operating mode, in which the height of a support for carrying and transporting a load is adjustable and the vehicle is supported on the crawler track and a support wheel.

Such a vehicle is known, for example, from EP 3 598 959 A1 originating from the applicant. In particular, the vehicle can be designed as a wheelchair, which is particularly comfortable for a user. In the above-mentioned third operating mode, the seat-shaped receptacle can be moved forwards so that the wheelchair can be driven under a table top.

The term “support wheel” used in this application is to be understood broadly and can include a hard rubber wheel, a pneumatic tire and in principle also a track of a crawler track.

In order to switch between the different operating modes, the crawler track and the support wheel or wheels must be moved to certain positions. For this purpose, the vehicle according to the invention has at least a first linear motor for adjusting the crawler track and a second linear motor for adjusting the support wheel or wheels. If the vehicle has two support wheels, a linear motor can also be assigned to each support wheel.

However, it has been found that high loads act on the linear motors under certain conditions. When the vehicle according to the invention is at the uppermost position in height adjustment mode, the force to be applied by the linear motor to adjust the crawler track is at a maximum. On the other hand, the linear motor of the crawler undercarriage must also apply a particularly high force when the vehicle is at the foremost position in height adjustment mode. The linear motor of the crawler undercarriage is almost exclusively subjected to pressure, while the linear motor for adjusting the support wheel is almost exclusively subjected to tension.

The invention is therefore based on the task of providing a vehicle for traveling on stairs or a ramp, in which both the linear motor of the crawler track and the linear motor of the support wheel are unloaded.

To solve this problem, in a vehicle of the type mentioned at the beginning, it is provided according to the invention that the vehicle has at least one first linear motor for adjusting the crawler track, a second linear motor for adjusting the support wheel, a lifting mechanism on which the first linear motor and the second linear motor are arranged, and a spring arranged on the lifting mechanism for relieving the load on the first and/or the second linear motor.

The invention is based on the realization that the first and/or the second linear motor can be relieved by the spring arranged on the lifting mechanism. In this way, the operating range of the linear motors can be shifted to a favorable range so that they are not loaded on one side.

In the context of the invention, it is preferred that the first linear motor for adjusting the crawler undercarriage is relieved by a tensile force generated by the spring, which counteracts a compressive force acting on the first linear motor. The compressive force is mainly generated by the vehicle's own weight and the weight of a person or load on the vehicle's mount. The spring thus serves to compensate for the compressive force and relieves the first linear motor for adjusting the crawler track.

A preferred variant of the invention provides that the spring is designed as a compression spring and is arranged in such a way that the second linear motor for adjusting the support wheel is relieved by a compressive force generated by the compression spring, which counteracts a tensile force acting on the second linear motor.

Preferably, the lifting mechanism of the vehicle according to the invention can have a main body on which the first linear motor and the spring are articulated. One end of the spring is thus attached to the main body, the other end of the spring can be attached to a strut to which the support wheel or the support wheels are attached.

A further embodiment of the invention provides that the vehicle has two springs or compression springs arranged in parallel. In this embodiment, the vehicle has two support wheels, to each of which one end of a spring is attached, with the other end of the spring being attached to the bracket. Alternatively, there may only be a single support wheel.

Preferably, the spring can be designed as a gas pressure spring, which generates a compressive force that serves to relieve the first linear motor for adjusting the crawler track and/or the second linear motor for adjusting the support wheel or support wheels. In addition, the gas pressure spring has the advantage that it dampens vibrations and has a flat spring characteristic curve so that a large compressive force can be generated even when extended. The gas pressure spring can be fitted in such a way that when the crawler undercarriage is driven, i.e. when driving up stairs or a ramp, a preload is generated that prevents rattling noises.

The vehicle according to the invention is particularly suitable for self-balancing operation in the first operating mode, in which parallel wheels of an axle are driven.

The vehicle according to the invention can be designed as a wheelchair with a receptacle designed as a seat. In the third operating mode, the height of the seat can be adjusted vertically and longitudinally as required, for example when the person using the vehicle is at a table.

The invention is explained below by means of an embodiment example with reference to the drawings. The drawings are schematic representations and show:

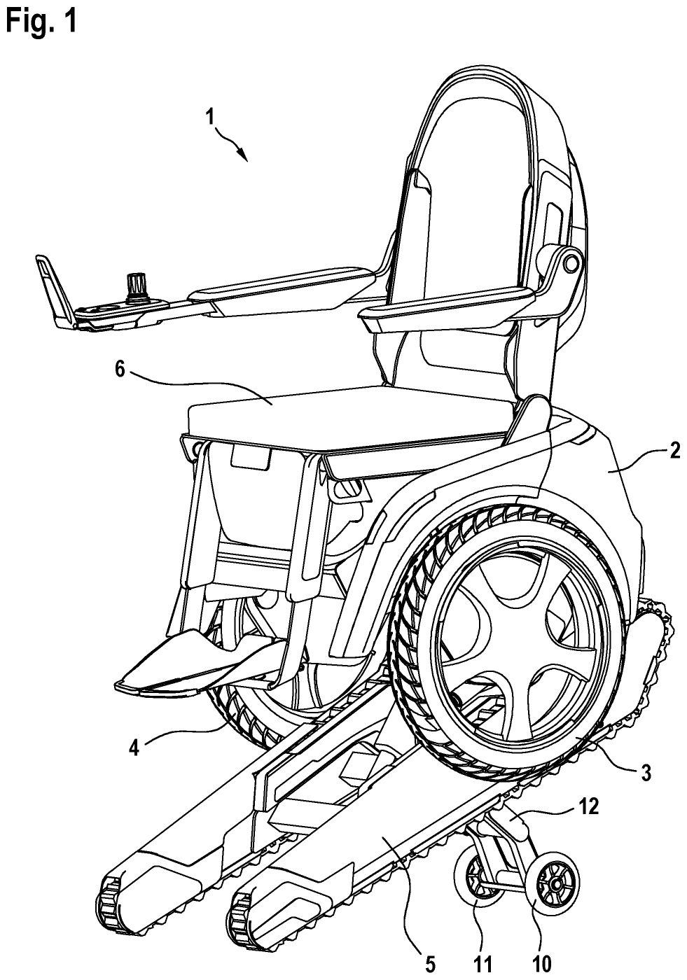

FIG. 1A perspective view of a vehicle according to the invention, which is designed as a wheelchair,

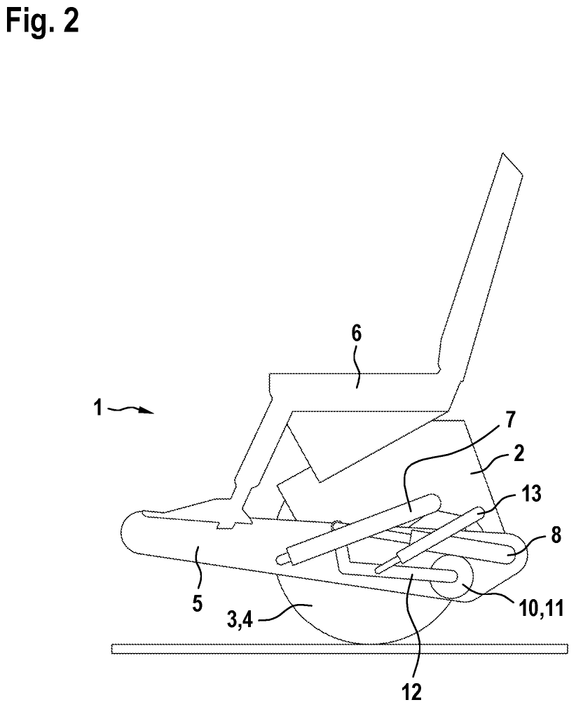

FIG. 2 a schematic side view of the vehicle according to the invention designed as a wheelchair in the first operating mode (driving mode),

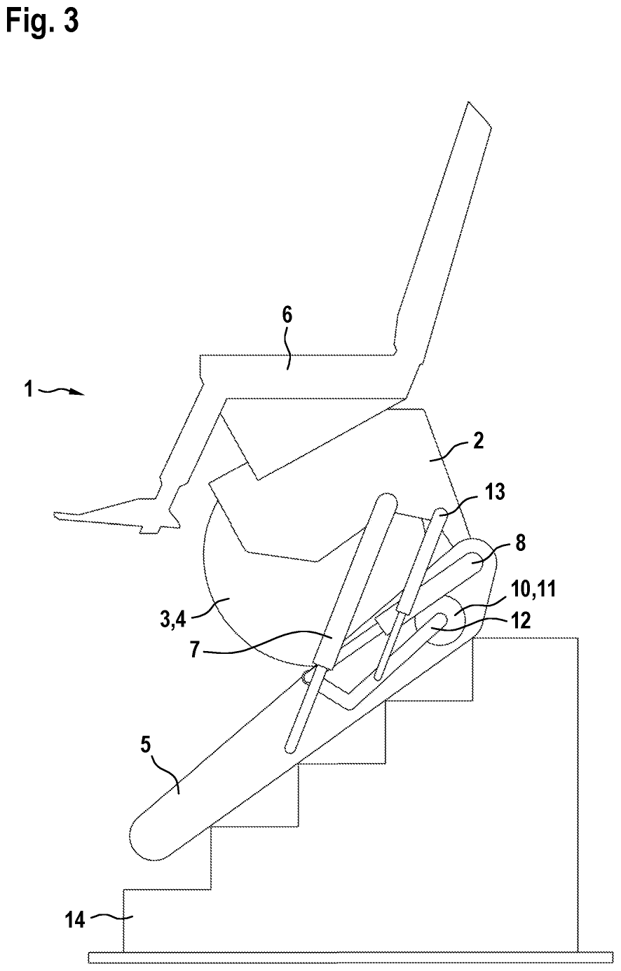

FIG. 3 the wheelchair shown in FIG. 2 in the second operating mode, when climbing stairs,

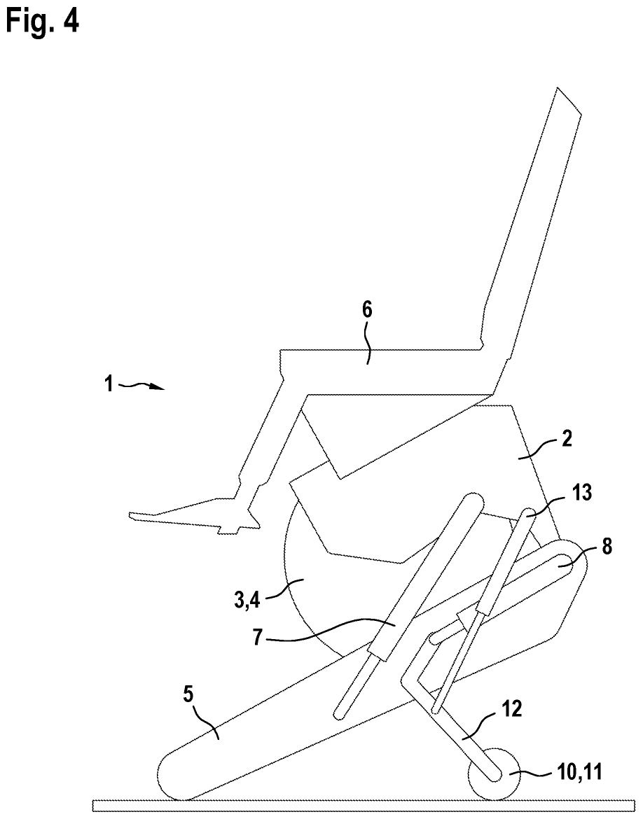

FIG. 4 the wheelchair shown in FIG. 2 in the third operating mode (height adjustment mode), in the upper position,

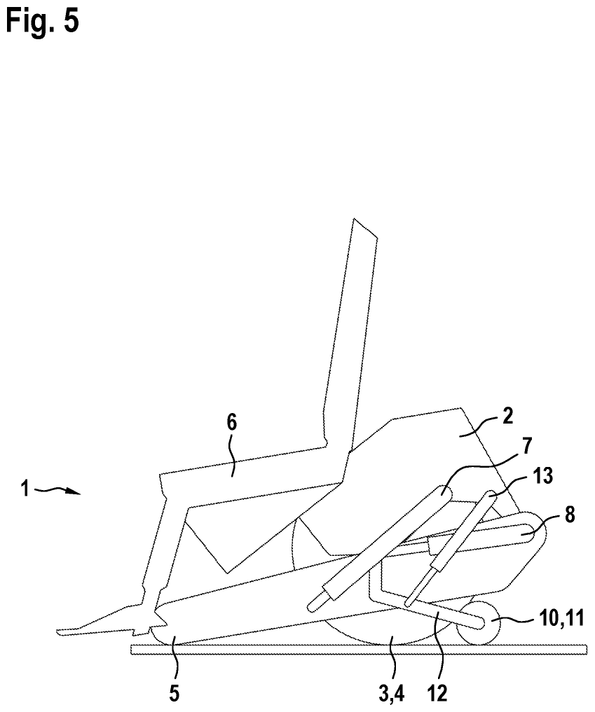

FIG. 5 the wheelchair shown in FIG. 2 in the third operating mode (height adjustment mode), in the lower position,

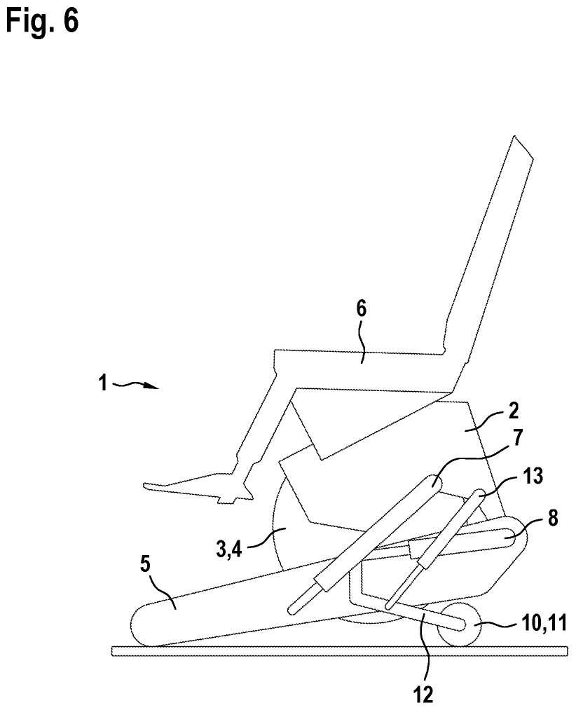

FIG. 6 the wheelchair shown in FIG. 2 when parked, and

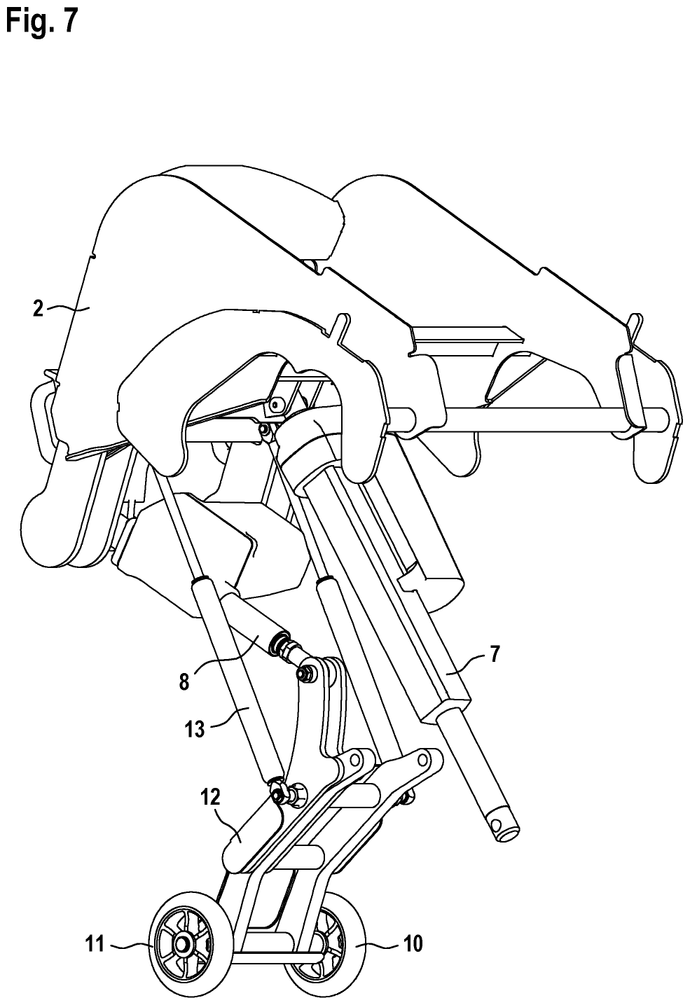

FIG. 7 the linear motors attached to the base of the wheelchair.

The wheelchair 1 shown in FIG. 1 comprises a main body 2, which is provided with wheels 3, 4 on both sides. The wheelchair 1 has an electric drive, not shown in detail, by which the wheels 3, 4 can be driven. The wheels 3, 4 are used for traveling on an essentially flat surface in a first operating mode. In addition, the wheelchair 1 has a crawler track 5, which comprises a slinging means in the form of a belt or chain. By means of the crawler track 5, the wheelchair 1 can drive up stairs or a ramp. In this second operating mode, the wheels 3, 4 are in a raised position. In the first operating mode, however, when the wheelchair 1 is moved by means of the wheels 3, 4, the crawler track 5 is in a raised position. By means of a controller (not shown), the drive can be controlled so that the wheelchair carrying the user is only supported and thus balanced by the wheels 3, 4. The wheelchair 1 is designed as a self-balancing vehicle.

FIG. 2 is a schematic side view of the vehicle designed as a wheelchair 1 in the first operating mode (driving mode). The wheelchair comprises a seat 6. In this first operating mode, the wheelchair 1 is self-balancing, i.e. only the two wheels 3, 4 touch the ground. Balancing is performed by the controller, which is connected to an inertial measurement unit (IMU) and controls the wheels 3, 4 using sensor data.

The wheelchair 1 comprises a linear motor 7, which is used to adjust the crawler track. One end of the linear motor 7 is attached to the crawler track 5, the other end is attached to the main body 2. The wheelchair 1 also includes a linear motor 8 for adjusting the support wheels 10, 11, which are attached to the same axle. In the side view of FIG. 2, the linear motor 8 and the left support wheel 10 are visible. One end of the linear motor 8 is attached to the main body 2 and the other end is attached to a strut 12 on which the left support wheel 10 is located.

A compressive force acts on the linear motor 7 for adjusting the crawler track 5, and a tensile force acts on the linear motor 8 for adjusting the support wheel 10. A spring designed as a compression spring 13, which is attached to the main body 2 on one side and to the strut 12 on the other, serves to relieve the linear motors 7, 8. The compression spring 13 generates a compressive force that counteracts the force generated by the weight of the wheelchair 1, which would otherwise have to be absorbed by the linear motors 7, 8, and thus relieves them. In this way, the working range of the linear motors 7, 8 can be better utilized.

FIG. 3 shows the wheelchair 1 climbing stairs 14. The wheels 3, 4 are in a raised position in relation to the crawler track 5, the support wheels 10, 11 are aligned approximately in the longitudinal direction to the crawler track 5. Accordingly, only the crawler track 5 touches the steps of the stairs 14.

FIG. 4 shows the wheelchair 1 in the third operating mode, in height adjustment mode, in the upper position. The wheelchair 1 is standing on a surface with the two support wheels 10, 11 and the front end of the crawler track 5. The wheels 3, 4 are in a raised position and are at a distance from the ground. The forces acting on the linear motors 7, 8 are reduced and at least partially compensated for by the compression spring 13.

FIG. 5 is a similar illustration as FIG. 4 and shows the wheelchair 1 in the third operating mode, in height adjustment mode, in the lower position. The center of gravity of the wheelchair 1 is shifted forward so that a maximum force acts on the linear motor 7 of the crawler track 5. However, the linear motor 7 is considerably relieved by the gas pressure spring 13. It can be seen that, starting from the state shown in FIG. 4, the wheels 3, 4 have been moved so far downwards that they are on the ground like the support wheels 10, 11 and the front end of the crawler undercarriage 5. At the same time, the seat 6 has been moved forwards in the longitudinal direction. This position is preferably selected when the user of the wheelchair 1 is sitting at a table.

FIG. 6 shows the wheelchair 1 in a parking mode, i.e. in a non-powered state. In accordance with the lower position of the height adjustment mode, the wheelchair 1 rests on the support wheels 10, 11 and the front end of the crawler track 1. However, the wheels 3, 4 are in a raised position in relation to this.

Finally, FIG. 7 shows the connection of the linear motor 7 to the main body 2. In FIG. 7, some components have been omitted for the sake of clarity. It can be seen that there are two parallel compression springs 13, which are attached at one end to the main body 2 and at the other end to the strut 12 of the support wheels 10, 11. This strut 12 is also engaged by the linear motor 8, the other end of which is also attached to the base 2 of the wheelchair 1. The outer lower end of the linear motor 7 in FIG. 7 is attached to the crawler track (not shown). The opposite upper end in FIG. 7 is attached to the main body 2.

In all the positions described, the compression spring 13 serves to generate a compressive force that counteracts the forces acting on the linear motors 7, 8, thereby reducing and at least partially compensating for them, so that the linear motors 7, 8 can be operated in an optimum operating range.

### LIST OF REFERENCES

1 wheelchair
2 main body
3 wheel
4 wheel
5 crawler track
6 seat
7 linear motor
8 linear motor
10 support wheel
11 support wheel
12 strut
13 pressure spring
14 stairs

1. Vehicle for driving up stairs or a ramp, whereby the vehicle can be operated in one of the following operating modes:
a first operating mode, intended for a substantially flat surface, in which one or more wheels (3, 4) are driven,
a second operating mode, which is intended for driving up stairs or a ramp, in which a crawler track (5) is driven,
a third operating mode in which the height of a support for carrying and transporting a load is adjustable and the vehicle is supported on the crawler track (5) and a support wheel (10, 11),
whereby the vehicle has:
at least one first linear motor (7) for adjusting the crawler track (5),
a second linear motor (8) for adjusting the support wheel (10, 11),
a lifting mechanism on which the first linear motor (7) and the second linear motor (8) are arranged, and
a spring arranged on the lifting mechanism to relieve the first linear motor (7) and/or the second linear motor (8).

2. Vehicle according to claim 1, wherein the spring is arranged in such a way that the first linear motor (7) for adjusting the crawler track (5) is relieved by a tensile force generated by the spring, which counteracts a compressive force acting on the first linear motor (7).

3. Vehicle according to claim 1 or 2, wherein the spring is designed as a compression spring (13) and is arranged in such a way that the second linear motor (8) for adjusting the support wheel (10, 11) is relieved by a compressive force generated by the compression spring (13), which counteracts a tensile force acting on the second linear motor (8).

4. Vehicle according to one of the preceding claims, wherein the lifting mechanism has a main body (2) on which the first linear motor (7) and the spring are articulated.

5. Vehicle according to one of the preceding claims, wherein two springs or compression springs (13) arranged in parallel are present.

6. Vehicle according to one of the preceding claims, wherein the spring is designed as a gas pressure spring.

7. Vehicle according to one of the preceding claims, which is designed to be operated in a self-balancing manner in the first operating mode.

8. Vehicle according to one of the preceding claims, which is designed as a wheelchair (1) with a receptacle designed as a seat (6).
